(19) United States
(12) Patent Application Publication
(10) Pub. No.: US 2018/0360061 A1
(43) Pub. Date: Dec. 20, 2018

(54) FAST HOME CURING DEVICE

(71) Applicant: Songyue Chen, Alhambra, CA (US)

(72) Inventor: Songyue Chen, Alhambra, CA (US)

(21) Appl. No.: 16/009,878

(22) Filed: Jun. 15, 2018

Related U.S. Application Data
(60) Provisional application No. 62/521,322, filed on Jun. 16, 2017.

(51) Int. Cl. A23B 5/20; A23B 5/18; A23L 15/00; A23L 3/015

(52) U.S. Cl. CPC A23B 5/20; A23B 5/18; A23V 2002/00; A23L 3/0155; A23L 15/30

(57) ABSTRACT

A fast home curing device comprises a top cover, a body and a power module. A pressure sensor, an electromagnetic valve, an air pump, a controller and a power module are disposed inside the chamber. The top cover and the body form a sealed space when combined. An electromagnetic valve air inlet is connected with a ventilating hole located on the outer surface of the top cover, an electromagnetic valve air outlet is connected with a venting tube disposed on a bottom of the top cover. An air pump air inlet is connected with a suction hole located on the bottom of the top cover, an air pump air outlet is connected with the ventilating hole. A pressure sensor output is coupled with a controller input. An air pump input and an electromagnetic valve input are coupled with a controller output respectively.

### CROSS-REFERENCE TO RELATED APPLICATION

This application claims the priority of provisional patent application U.S. Ser. No. 62/521,322 filed Jun. 16, 2017 which is expressly incorporated by reference herein in its entirety.

### TECHNICAL FIELD OF THE INVENTION

The present application pertains to kitchen appliances, and more particularly, to a fast home curing device for curing small amounts of eggs quickly.

### BACKGROUND OF THE INVENTION

Salted eggs, especially salted duck eggs, chicken eggs, and goose eggs, are a common food item in Chinese cuisine. The traditional method of curing entails packing large batches of fresh eggs with salt, leaving them to cure for weeks, and then boiling to finish the cooking process. It is well known that this process results in a high-sodium, unhealthy product that takes a relatively long time to complete. Additionally, the quality of the salted eggs made in this manner is inconsistent. The taste is often inconsistent, either being excessively salty or generating odor due to gradual deterioration. Also, since the same batch of eggs cannot be consumed all at once, these problems are exacerbated, since the eggs will become saltier as they sit in the salt solution. A large batch process also makes it difficult to meet the tastes of many different consumers.

### SUMMARY OF THE INVENTION

For existing technical problems, the present application discloses a fast home curing device with simple structure, short processing cycle and low cost.

The fast home curing device comprises a top cover, a body and a power module. A pressure sensor, an electromagnetic valve, an air pump, a controller and a power module are disposed inside the chamber. The top cover and the body form a sealed space when combined. The power module may provide power. An electromagnetic valve air inlet of the electromagnetic valve is connected with a ventilating hole located on the outer surface of the top cover, an electromagnetic valve air outlet of the electromagnetic sake is connected With a venting tube disposed on a bottom of the top cover. An air pump air inlet of the air pump is connected with a suction hole located on the bottom of the top cover, an air pump air outlet of the air pump is connected with the ventilating hole. A pressure sensor output of the pressure sensor is coupled with a controller input. An air pump input of the air pump and an electromagnetic valve input of the electromagnetic valve are coupled with a controller output respectively.

In various exemplary embodiments, the fast home curing device further comprises a rubber ring disposed at a location where the top cover is combined with the body.

In various exemplary embodiments, the fast home curing device further comprises a positioning member disposed on a lower pan of the top cover.

In various exemplary embodiments, wherein the top cover comprises a lid and a base plate, the chamber is formed after combing the lid with the base plate.

In various exemplary embodiments, wherein the electromagnetic valve is connected with the air pump via the ventilating tube and the ventilating hole.

In various exemplary embodiments, the fast home curing device further comprises a display and a keyboard disposed on an outer surface of the top cover. A keyboard output of the keyboard is coupled with the controller input. A display input of the display is coupled with the controller output.

In various exemplary embodiments, the fast home curing device further comprises a waterproof cover disposed on the suction hole.

In various exemplary embodiments, a shape of the body is quasi-spherical.

The present application works as follows: an egg's contents are gelatinous and the eggshell is porous. By constantly changing the external environmental pressure (water pressure or air pressure) of the egg, small amounts of substances can be exchanged between the inside and outside of the eggshell, substituting the osmosis in the traditional process. The fast home curing device of the present application uses this characteristic to create unidirectional salt movement from outside of the eggshell to inside of the eggshell. In the traditional batch process of curing eggs, the solute salt is diffused into the eggshells in solvent water. The curing speed is very slow; the cycle is calculated in terms of months, since the diffusion is a molecular random movement. The fast home curing device of the present application adopts the air pump and the electromagnetic valve to change the air pressure in a microenvironment. Because it is a physical mechanism, the speed of salt exchange is greatly accelerated compared with simple diffusion, realizing the purpose of quickly curing the eggs.

The advantages of the present application are:
1. A manufacturing process of the fast home curing device of the present application not only provides full participation for a user but also has the advantages of easy processing with small batches, solving the difficulty of cleaning the mess resulting from the existing manufacturing technology.
2. A processing cycle of the fast home curing device of the present application is short. The user can produce a salted egg in only a few hours in accordance with his/her personal taste. In addition, it is also available for manufacturing in a small amount. Since the batch can be as small as only one egg and with a short cycle of a few hours, the, quality can be controlled in daily cooking. The fast home curing device of the present application is the best choice for taste-picky people since they can figure out the best mode for themselves after several attempts. Since the cycle is shortened, there are more opportunities to experiment with the taste to produce the desired flavors for the salted egg, such as sweet, sour, spicy or mixed taste etc., expanding the concept of taste without being limited in traditional taste of sailed eggs,
3. The fast home curing device is suitable for promotion because of its low cost and simple structure. In addition, since the user can purchase the ingredients by himself herself, the food safety requirement can be met.

As is common with the emergence of new technology today, many traditional processes and products are, being outdated. The old ways of manufacturing salted eggs by a large tank or a large pond of brine will eventually be obsolete. The present application can be used at home for further modernization.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is an overall structural view of a fast home curing device according to one embodiment of the present application.

FIG. 2 is a structural view of a top cover of the fast home curing device in FIG. 1.

FIG. 3 is a bottom view of the top cover of the fast home curing device in FIG. 2 after removing a base plate.

FIG. 4 is a circuit block diagram of a control circuit of the present application.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

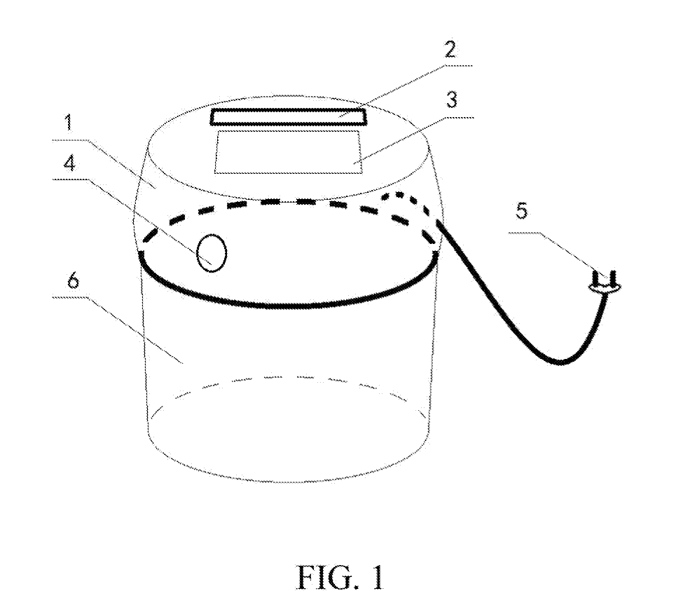

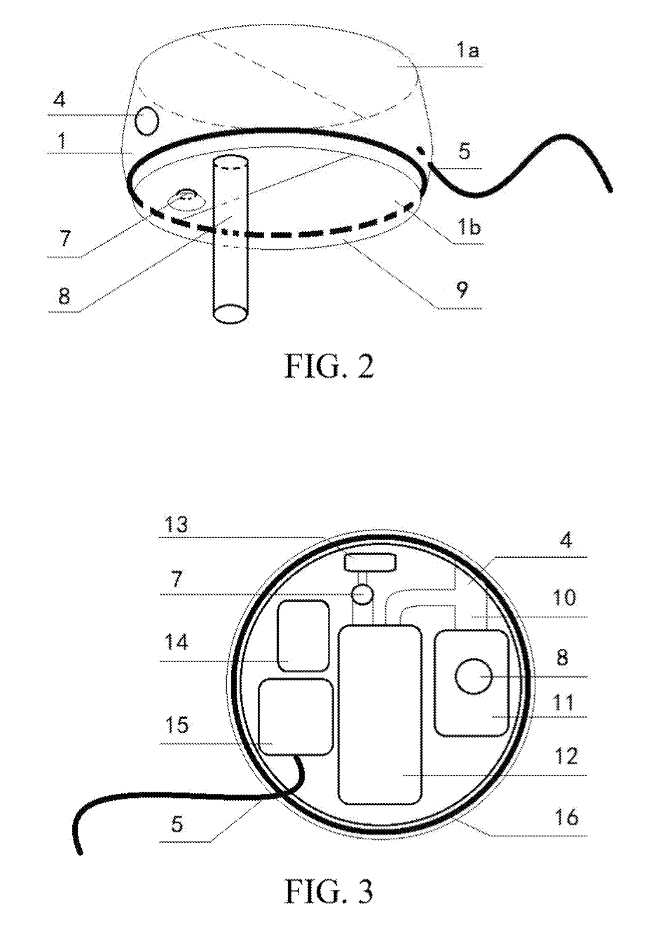

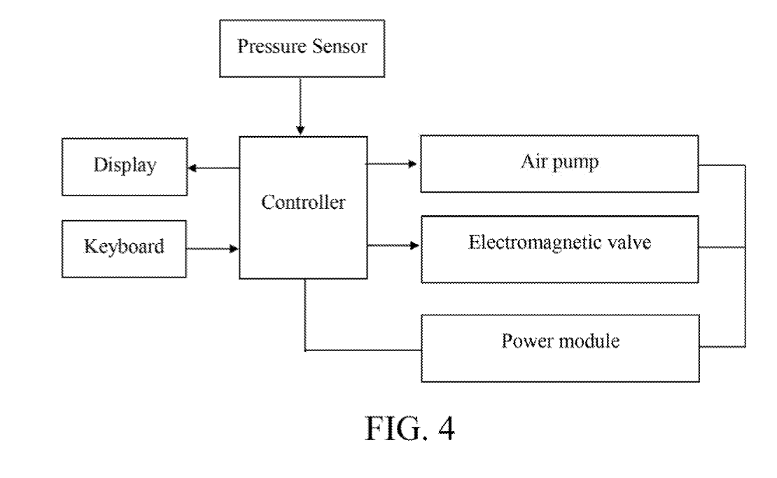

As shown in FIGS. 1-4, a fast home curing device comprising a top cover 1 and a body 6. A compressive sealed space is formed after combining the top cover 1 and the body 6. A chamber is inside the top cover 1. A pressure sensor 13, an electromagnetic valve 11, an air pump 12, a controller 14 and a power module 15 are disposed inside the chamber respectively. A display 2 and a keyboard 3 are disposed on an outer surface of the top cover 1. An electromagnetic valve air inlet is connected with the ventilating hole 4 located on outer surface of the top cover 1 via a ventilating tube 10. An electromagnetic valve air outlet is connected with a venting tube 8 disposed on a bottom of the top cover 1. The venting tube 8 may be either long or short. The venting tube 8 may be as long as being close to a bottom of the body for making water spray. The venting tube 8 can also be as short as staying above the surface of water. An air pump air inlet is connected with a suction hole located on the bottom of the top cover 1. This is the only channel for forming negative pressure. An air pump air outlet is connected with the ventilating hole 4 via the ventilating tube 10. In order to prevent the suction hole from intaking water, a waterproof cover is disposed on the suction hole. A pressure sensor output and a keyboard output are coupled with a controller input. A display input, an air pump input and an electromagnetic valve input are coupled with a controller output respectively. The power module 15 is coupled with the controller 14, the air pump 12 and the electromagnetic valve 11 respectively for providing different voltage of direct current (DC) to other components.

In order to increase the impermeability after combining the top cover 1 with the body 6, a rubber ring 16 is disposed at a location where the top cover 1 is combined with the body 6.

In order to bond accurately when combining the top cover 1 with the body 6, a positioning member 9 is disposed on a lower part of the top cover 1.

The top cover 1 comprises a lid 1a and a base plate 1b. The chamber is formed after combining the lid 1a with the base plate 1b by closing the lid 1a onto the base plate 1b. The base plate 1b is hard and compressible. The pressure sensor 13, the electromagnetic valve 11, the air pump 12 the controller 14 and the power module 15 are installed on the base plate 1b respectively. The display 2 and the keyboard 3 are installed respectively on the top of the lid 1a for easy operation. The lid 1a comprises an opening for coupling the display 2 and keyboard 3 with the controller 14 which is inside the lid 1a. There are two holes on the side surface of the lid 1a: one is the ventilating hole 4, and the other is used to pass through a power cable connected to the power module 15. Since the lid 1a does not need to sustain air pressure changes, there is no problem with the ventilating hole 4 on the lid 1a. There are two holes on the base plate 1b. One of them is the suction hole with the water proof cover, another one is for connection with the venting tube 8. A detection end of the pressure sensor 13 is disposed near the suction hole, allowing the pressure sensor 13 to be connected with an air space above the water surface inside the body 6 by passing through the suction hole, and then obtaining the air pressure data in real time. The positioning member 9 is disposed on the base plate 1b. The positioning member 9 and the base plate 1b are molded integrally.

The pressure sensor 13, the electromagnetic valve 11, the air pump 12, the controller 14, the power module 15, the display 2, the keyboard 3, the ventilating hole 4, the plug and the power cable 5, the suction hole and waterproof cover 7, and the venting tube 8 also can be centralized on the body 6.

The curing device can increase or decrease pressure inside the chamber from normal atmospheric pressure. However, increasing pressure requires a pressurized container, which has dangerous tendencies. It should not be used, unless it is necessary. Alternatively, decreasing the pressure in the device is safer because any unexpected failures would result in an implosion and not an explosion. In addition, the risk is greatly mitigated since only low-power electrical appliances are used and there are no heating components. In order to cope with the negative pressure working condition, a shape of the body 6 of the present application is quasi-spherical. Specifically, the shape of the body 6, should be as close to a sphere as possible to resist the pressure difference between the atmospheric pressure outside the body 6 and the negative pressure inside the body 6. The larger proportion of spherical surface, the thinner the wall of the body 6 can relatively be, saving more materials. The top cover 1 and the base plate 1b have the same concept.

The operation of the present application will be described with reference to the accompanying drawings.

As shown in FIGS. 1-4, when using it, put the suitable amount of salt solution or brine and a few washed eggs in the body 6, and then tightly close the top cover 1. After that, couple the power module 15 with electricity via plug and power cable 5. An automatic control operation will be started after finishing the input by pressing the keyboard 3 according to the instructions shown on the display 2. First, the controller 14 controls the electromagnetic valve 11 to close, and then operates the air pump 12. The pressure sensor 13 starts to detect the pressure and send the feedback of the pressure data to the controller 14. When the pressure inside the body 6 drops to the preset negative pressure, the controller 14 controls the air pump 12 to close and maintains the negative pressure until the end of the negative pressure cycle, and then open the electromagnetic valve 11. At the beginning, it is the pressure gradient between the inside and outside of the egg that makes the contents of the egg diffuse out. After opening the electromagnetic valve 11, the outside air passes through the ventilating hole 4, ventilating tube 10 and the electromagnetic valve 11 sequentially, and then is discharged to the bottom of the water via the venting tube 8. The bottom of the egg in the salt water is stricken by the air in the form of water spray, eliminating tiny bubbles attached on outer surface of the eggshell. After that, the air floats out of the water, making the pressure inside and outside the body 6 meet the standard atmospheric pressure. At this moment, the pressure inside the egg is less than the pressure outside, resulting in the salt diffusing into the egg according to the salt concentration gradient. This operation is repeated until the stop command is received. Then, the air pump 12 is closed and the electromagnetic valve 11 is opened. Open the fast home curing device to take eggs out after finishing air exchange. At this point, the eggs reach a certain salt concentration and can be cooked.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A fast home curing device comprising:
a top cover, a chamber is formed inside the top cover, wherein a pressure sensor, an electromagnetic valve, an air pump, a controller and a power module are disposed inside the chamber;
a body, wherein the top cover and the body form a sealed space when combined; and
a power module for providing power,
wherein an electromagnetic valve an inlet of the electromagnetic valve is connected with a ventilating hole located on the outer surface of the top cover, an electromagnetic valve air outlet of the electromagnetic valve is connected with a venting tube disposed on a bottom of the top cover,
wherein an air pump air inlet of the air pump is connected with a suction hole located on the bottom of the top cover, an air pump air outlet of the air pump is connected with the ventilating hole,
wherein a pressure sensor output of the pressure sensor is coupled with a controller input;
wherein an air pump input of the air pump and an electromagnetic valve input of the electromagnetic valve are coupled with a controller output respectively.

2. The fast home curing device as claimed in claim 1, further comprising a rubber ring disposed at a location where the top cover is combined with the body.

3. The fast home curing device as claimed in claim 1, further comprising a positioning member disposed on a lower part of the top cover.

4. The fast home curing device as claimed in claim 1, wherein the top cover comprises a lid and a base plate, the chamber is formed after combing the lid with the base plate.

5. The fast home curing device as claimed in claim 1, wherein the electromagnetic valve is connected with the air pump via the ventilating tube and the ventilating hole.

6. The fast home curing device as claimed in claim 1, further comprising a display and a keyboard disposed on an outer surface of the top cover.

7. The fast home curing device as claimed in claim 6, wherein a keyboard output of the keyboard is coupled with the controller input.

8. The fast home curing device as claimed in claim 6, wherein a display input of the display is coupled with the controller output.

9. The fast home curing device as claimed in claim 1, further comprising a waterproof cover disposed on the suction hole.

10. The fast home curing device as claimed in claim 1, wherein a shape of the body is quasi-spherical.
